(19) United States
(12) Patent Application Publication
(10) Pub. No.: US 2012/0288590 A1
(43) Pub. Date: Nov. 15, 2012

(54) Edible Surface-Modifying Particles and Methods for Their Manufacture

(75) Inventors: David S. Soane, Chestnut Hill, MA (US); Lauren Fortin, Stow, MA (US); George Courville, Winchester, MA (US)

(73) Assignee: Durafizz, LLC

(21) Appl. No.: 13/371,892

(22) Filed: Feb. 13, 2012

Related U.S. Application Data
(63) Continuation of application No. PCT/US10/48246, filed on Sep. 9, 2010.
(60) Provisional application No. 61/240,845, filed on Sep. 9, 2009.

(51) Int. Cl. A23L 1/176; A23L 1/0524; A23L 1/31; A23L 1/10; A23L 1/325; A23L 1/212; A23L 1/216; A23L 1/0522; A23P 1/08; A23L 1/315

(52) U.S. Cl. 426/92; 426/577; 426/578; 426/96; 426/293; 426/296; 426/658; 426/622; 426/618; 426/243

(57) ABSTRACT

Disclosed is an edible surface-modifying particle precursor composition for preparing edible surface-modifying particles that includes one or more starches resulting in a total amylose content from the starches of about 0.1% to about 20% of the total weight of the composition. The composition also includes a ground cereal in amounts of about 10% to about 40% of the total weight of the composition; and water. Disclosed also are coated food substrates bearing such edible surface-modifying particles, and methods for making food products using the edible surface-modifying particles.

### RELATED APPLICATIONS

This application is a continuation of International Application No. PCT/US2010/048246, which designated the United States and was filed on Sep. 9, 2010, published in English, which claims the benefit of U.S. Provisional Application No. 61/240,845, filed on Sep. 9, 2009. The entire teachings of the above applications are incorporated herein by reference.

### FIELD OF APPLICATION

This application relates to edible texture-modifying particles that can be used to produce surface coatings in food products, and to methods for their manufacture.

### BACKGROUND

Food products such as ready-to-eat entrees, frozen/refrigerated foods, fried foods and snacks are frequently flavored and/or textured with edible food particulates. The edible food particulates can be coated on the surface or incorporated into the food. As examples, potato chips, tortilla chips, pretzels, crackers, popcorn, chicken nuggets, fish sticks, French fries and numerous other foodstuffs often have seasonings and or breading applied to them during processing. Seasonings and breadings used can include salt, cheese, chili, garlic, Cajun spice, ranch, bread crumbs and panko crumbs, among many others.

Adhering particulate matter to food products may involve the use of a food-grade adhesive. For example, oil may be used as an adhesive for attaching seasonings to certain foodstuffs. According to this technique, an extruded and cooked food product can be immersed in an oil and seasoning slurry at an elevated temperature. The product can then be dry-coated with seasonings, sprayed with seasonings, sprayed with heated or room temperature oils containing seasonings, or dusted with seasonings. U.S. Pat. No. 4,529,607 and U.S. Pat. No. 4,595,597 disclose high amylose coatings for the preparation of pre-fried microwavable foodstuff.

As an example, breaded prepared foods that are frozen often rely on batters to adhere to substrates. These food products include breaded chicken and other meats, breaded fish, breaded cheese sticks, onion rings, etc. However, for foodstuff with moisture cores, the coating often becomes moist and soggy upon storage. It is highly desirable to develop a processing method where a food core can be coated with crunchy or crispy textured outer layer without losing the texture, taste or integrity of the inner core.

In case of food products that require long shelf life, they often lose their initial texture, taste and moisture content. Hence, methods of preparing food products that can protect from loss of texture, moisture loss and changes to taste are desirable. Therefore, the capacity to modify surface properties of foodstuff to improve texture, taste and shelf life are important for food industry. Improving taste and texture on the surface of the food can also improve the overall attractiveness of a blander core. Furthermore, the adhesion of edible particles is desirable for refrigerated/frozen, raw or precooked foods that are reconstituted prior to serving, e.g., through means of heating.

It would be advantageous, therefore, to improve the adherence of flavorings and texturing agents to food products. It would further be desirable to provide an adherence system adaptable to a number of flavorings, texturing agents and food product substrates. It may also be desirable in a food product to create a texture that enhances its mouth feel or other aesthetic properties, while achieving certain of the aforesaid advantages.

### SUMMARY

Disclosed herein are food products with edible surface-modifying particle coatings and methods for producing them. In embodiments, edible surface-modifying particle coatings can be prepared by hydrating grain meal and starches, preferably pregelatinized grain meal and pregelatinized starches. In embodiments, edible surface-modifying particle precursor composition for preparing edible surface-modifying particles contain one or more polysaccharides wherein about 80 to about 100% of the polysaccharides are branched polysaccharides wherein said branched polysaccharides is about 25 to about 75% of the dry weight of the composition; and a grain meal wherein the grain meal is about 25 to about 75% of the dry weight of the composition. A preferred group of polysaccharides are starches containing amylose and amylopectin.

Starches that contain a higher amount of amylopectin than amylose are preferred. Some amount of amylose-containing starch can be present to modify or adjust the texture of the coating. The invention further relates to an edible surface-modifying particle precursor composition for preparing edible surface-modifying particle coatings comprising one or more starches resulting in a total amylose content from said starches of about 0% to about 20% of the total weight of the composition. In another embodiment, the invention is directed to an edible surface-modifying particle precursor composition for preparing edible surface-modifying particle coatings comprising one or more starches resulting in a total amylose content from said starches of about 0% to about 20% of the total weight of the composition, and about 10% to about 40% ground cereal. In yet another embodiment, the invention is directed to an edible surface-modifying particle precursor composition for preparing edible surface-modifying particle coatings comprising one or more starches resulting in a total amylose content from said starches of about 0% to about 20% of the total weight of the composition, about 10% to about 40% ground cereal and water. In certain embodiments, an edible adhesive coating may be prepared for adhering edible surface-modifying particles to food substrates. In particular embodiments, the edible adhesive batter composition comprises one or more starches resulting in total amylose content from said starches of about 0% to about 20% of the total weight of the composition, about 1% to about 20% ground cereal, and water. In particular embodiments, the edible adhesive mixture comprises one or more starches resulting in total amylose content from said starches of about 0% to about 20% and about 1% to about 20% ground cereal. In embodiments, the invention relates to an improved food product comprising food substrate, optionally an edible adhesive batter coating deposited on a surface of said food substrate and an edible surface-modifying particle deposited on the edible adhesive coating.

Disclosed herein are edible surface-modifying precursor compositions for preparing edible surface-modifying particles, comprising one or more starches resulting in a total amylose content from said one or more starches of about 0% to about 20% of the total weight of the composition; and a ground cereal comprising about 10% to about 40% of the total weight of the composition. In embodiments, edible surface-modifying precursor compositions for preparing edible surface-modifying particles, comprising one or more starches resulting in a total amylose content from said one or more starches of about 0% to about 20% of the total weight of the composition; a ground cereal comprising about 10% to about 40% of the total weight of the composition; and water are disclosed. As used herein, the term “cereal” refers to a grain, preferably pregelatinized (e.g., pregelatinized corn meal, pregelatinized barley meal, pregelatinized rice meal, etc.) grains. Generally, pregelatinized grain meal can be prepared from grains such as cereal grains, including corn, barley, wheat, and rice by cooking. In a preferred embodiment, grain meal is ground before pregelatinization. In a preferred embodiment, pregelatinized grain meal is prepared by milling, grinding or homogenizing cooked grains. Disclosed herein, in embodiments, are compositions for preparing edible surface-modifying particles comprising about 10% to about 40% waxy corn starch, about 1.0% to about 10% rice starch, about 1.0% to about 10% converted tapioca starch, about 10% to about 30% corn meal, and water. Also disclosed herein are edible adhesive compositions comprising one or more starches resulting in a total amylose content from said starches of about 0.01% to about 10% of the total weight of the composition, a ground cereal or a combination of ground cereals comprising about 1% to about 20% of the total weight of the composition and water. More or less water can be added depending upon the desired viscosity of the final edible surface-modifying particle precursor before sheeting. Further disclosed herein are methods for making a food product, comprising the steps of coating a food substrate with edible surface-modifying particles to form a particle-coated food substrate, and optionally cooking said edible surface-modifying particle-coated food substrate.

### DETAILED DESCRIPTION

Disclosed herein are systems and methods for preparing coatings with desirable aesthetic properties and adhering them to food surfaces. In certain embodiments, textured coatings can be provided for food substrates that impart crispy, crunchy or other desirable auditory, gustatory or kinesthetic properties to the prepared food product. In embodiments, the edible surface-modifying particulates disclosed herein can be attached to food substrates via an edible adhesive batter coating. In embodiments, the systems and methods can involve applying tacky edible coatings to food surfaces to adhere edible surface-modifying particulates thereto. In other embodiments, the systems and methods can rely upon the chemical properties of the food surface itself to permit attachment of edible surface-modifying particles thereto, for example upon the application of heat.

In embodiments, edible surface-modifying particle coatings can be prepared by hydrating grain meal and starches, preferably pregelatinized grain meal and pregelatinized starches. In embodiments, an edible surface-modifying particle precursor composition for preparing edible surface-modifying particles can contain one or more polysaccharides wherein about 80 to about 100% of the polysaccharides are branched polysaccharides wherein said branched polysaccharides is about 25 to about 75% of the dry weight of the composition; and a grain meal wherein the grain meal is about 25 to about 75% of the dry weight of the composition. A preferred group of polysaccharides are starches containing amylose and amylopectin. In a preferred embodiment, starch is composed of about 80-100% amylopectin, preferably of about 90-100% amylopectin.

In embodiments, edible surface-modifying particles can be prepared by hydrating starches and grain meal; preferably, pregelatinized grain meal and pregelatinized starches. Starches that contain a higher amount of amylopectin starch than amylose are preferred. Starches are combined to create the desired texture. As an example, a preferred range may contain approximately 0-20% amylose, and more preferably 10-15% of amylose, of the total starch and meal portions included in the formula. Additional amylose containing starches may be present to modify the texture of the coating.

In some embodiments, an edible surface-modifying particle precursor (e.g., a dough or similar precursor material for the edible surface-modifying particles) can be formed from hydrated pregelatinized grain/starch mixture and further processed. For example, a material having a dough-like consistency can be flattened and baked to a low-moisture, porous, cracker-like material. The resulting processed precursor material can be ground into various particulate sizes. Such particulates can be easily affixed onto moist food substrate surfaces, due to the capability of adsorbing water leading to tackiness of the particulates. If a substrate does not have sufficient surface moisture available, an edible adhesive layer or a light layer of water may be used to affix the particles. Food substrates may be raw (e.g., chicken, potatoes, fish, etc.) at the time they are coated with the edible surface-modifying particles as disclosed herein. These foods can be further cooked after the coating is added, where the edible surface-modifying particle coating can dry out and set onto the food substrate surface. Food substrates (e.g., chicken, potatoes, fish, etc.) may also be partially or fully cooked before they are coated with the edible surface-modifying particles as disclosed herein.

Without being bound to any particular theory, it is postulated that during product storage, edible surface-modifying particle coatings are capable of adsorbing water from the affixed food substrate or from the surrounding environment (e.g., refrigerator, freezer). Water can then become trapped within the branched amylopectin portions of the starch. When the coated food substrate is reconstituted in a microwave or an oven, the starch can turn from glassy to rubbery due to the heat and moisture present. The moisture trapped within the amylopectin branches can quickly turn into steam, and a pressure differential forms within the rubbery portion of the crumb. This pressure differential may create cell structure, voids and pathways for the water to escape. The light and elastic composition of the material allows for easy moisture escape and expansion of cell structures. When such cell-structure sets, through the release of excess moisture or change of state back to glassy, the resultant material forms as a rough surface particulated coating, (i.e., a rough/bumpy-looking surface coating that increases the surface area and thereby can permit easier/quicker moisture release) that has improved texture and overall surface properties. During the rubbery state of the edible surface-modifying particles, particles of small size (e.g. ˜0.2 mm) may melt together to form a rigid, granular surface coat layer. This may be advantageous for some food products where intact, individually discernible particles may not be desirable. Otherwise, larger particles can be made to desired size and shape. The particulated, rough surface coating allows for a greater surface area and more efficient surface heating in combination with the above, leading to improved texture. The edible surface-modifying coating portrays a glassy, bubbly look that can be designed to look like a fried product surface.

In embodiments, an adhesive coating according to these systems and methods can first be prepared, then applied to the food product by, for example, brushing, spraying or tumbling it onto the food surface or submersing the food into the coating mixture. In an embodiment, the coating may be pre-dried to a tacky state, then tumbled with particulates, or immediately tumbled/coated with particulates once the coating has been applied. The food product, for example, a snack food, is then dried to the desired moisture content and water activity. Other methods of application would be familiar to those having ordinary skill in the art.

Adhesive coatings and particle-on-surface technologies capable of binding particulates to food surfaces increase the adhesion between the particle and surface and therefore prolong the duration of their attachment to food surfaces while maintaining desired sensory characteristics of the product.

This invention further relates to the adherence of texture-altering particulates onto food substrate surfaces. As an example, edible surface-modifying particles can be used to create a crispy texture on food surfaces. Edible surface-modifying particulates having crispy or crunchy properties can be prepared, for example, by processing a combination of pregelatinized starches and meals into edible surface-modifying particle precursors and baking until a low-moisture/low-water activity cooked product is formed. The cooked product can then be milled into smaller particles, e.g., crumb-like pieces, and adhered onto edible substrates with a thin layer of adhesive batter or by affixing with moisture addition.

Substrates suitable for affixation of edible surface-modifying particles can be coated raw, partially-cooked, or fully cooked. Once the substrate is coated, it can be heated or cooked further (e.g. baking) to set the coating and partially or fully bake the substrate. Baking includes cooking by heat in an oven or on heated metal or stones. Other methods of heating such as sun drying and hot baths can also be used. Particulate coated, edible substrates can then be preserved (e.g., refrigerated or frozen) until ready for consumption. During storage, the once low moisture and low water activity particles take up moisture from the environment and food substrate, until equilibrium is reached. In embodiments, it is desirable for the edible surface-modifying particle coating to take up moisture during storage, thereby aiding in the development of texture-enhancing (e.g., crisping) properties during reconstitution. Once the food product prepared in accordance with these systems and methods is ready to be consumed, it can be reconstituted through traditional methods known in the art (e.g., oven baking, convection oven baking, microwaving with or without susceptor packaging, grilling, pan frying, deep frying, infrared frying, high speed cook oven, etc.). The adhered particulates, remaining intact, can provide a crisp, crunchy or other desirable texture on the surface of the food substrate.

In embodiments, the systems and methods disclosed herein can be advantageously employed for creating unique textures on food substrate surfaces. For example, particulates can be added to substrates (meats, vegetable, fish, cheese, etc.), allowing for crispy or other texturally desirable coatings on cooked food products. These particulates may be adhered to the food substrate with an adhesive batter, or by addition of oil, or by formulating particulates that attach to the substrate by virtue of their own intrinsic characteristics and/or those of the substrate. For example, edible texture-modifying particulates can be formed that contain hygroscopic polymers, so that the particulates can affix to the food substrate when they encounter moisture. These particles containing hygroscopic polymers (e.g., pregelatinized/gelatinized starch) adsorb water and are able to adhere to surfaces.

In embodiments, edible surface-modifying particles can be prepared with starches and grain meal. Pregelatinized starches and grain meals are advantageously employed, although starches and grain meals that become gelatinized during processing can also be employed. For example, starches that are high in amylopectin (waxy starches) can be used, either alone or in combination with other starches containing amylose to obtain a desirable texture. Starches may be used from a variety of sources (e.g., corn, potato, rice, tapioca, tubers, arrowroot, buckwheat, sorghum, wheat, barley, oat, millet, rye, yam, etc.). Starches may be physically or chemically modified or unmodified in natural state. As an example, native or pregelatinized corn meal can be used, either alone or in combination with other whole grains (e.g., whole grain rice, oats, barley, wheat, buckwheat, spelt, rye, etc.). Edible surface-modifying particles may also contain protein ingredients (e.g., soy, whey, egg, casein, etc.), carbon dioxide producing agents (e.g., bicarbonate salts, baking powder, etc.), sodium or other taste enhancers (e.g., MSG, salts, yeast extract, etc.), fats (e.g., vegetable oils, shortening, lard, butter, etc.), dextrose, maltodextrin, and emulsifiers. Edible surface-modifying particles may be formulated to melt and/or congeal during baking to create a texturized, homogeneous surface coating on the substrate surface capable of crisping upon heating.

In certain embodiments, one or more polymers and/or edible food components having adhesive properties can be used to attach particles to food surfaces. As an initial step, the selected polymer(s) and/or edible food components are allowed to disperse and/or dissolve in water or solvent before coating to form a coating mixture. In embodiments, polymers or oligomers such as Gum Arabic, carboxymethyl cellulose (CMC), hydroxypropyl methyl cellulose (HPMC), carrageenan, pectin, xanthan gum, pullulan, alginates, soluble fiber (e.g., fructooligosaccharides, inulin), proteins (e.g., casein, egg albumen, wheat gluten, or whey), amino acids, starches, shellac, zein, polyvinyl alcohol, polyvinyl acetate, and the like, can be used as additional ingredients in the adhesive compositions.

In embodiments, protein-containing materials used to prepare surface-modifying particles can include, without limitation, soy protein concentrate, soy protein isolate, whey protein isolate, whey protein concentrate, egg albumin, egg white protein, legume proteins, wheat protein, gluten, zein, and hydrolyzed protein. Proteins may create foams or gels to create surface-modifying particles. Solubilizing and whipping the proteins to create foams can be coated onto food products and set by baking. Protein foams may be combined with starches or other materials (acidic materials, sugars, etc.) to properly stabilize the foams. Proteins may be applied directly onto a food product surface or as a pre-layer, underneath the final coating layer. The pre-layer can be hydrophobic and aid in prevention of moisture migration from the product core to the outer most coating layer. This protein layer can either be applied as a dry layer, or solubilized, or dispersed protein into an aqueous liquid or fat/oil. Protein layers my also be sprayed onto surfaces of modifying surface particles to prevent excess moisture migration. Fats and/or oils may also be sprayed to create a hydrophobic layer.

Preferred starches are selected from waxy corn starch, rice starch, potato starch, waxy rice starch and waxy potato starch. Waxy corn is a corn variety with grains that have a waxy appearance when cut, and that contains mostly branched-chain starch. Waxy corn starch is generally very high in amylopectin, and can be over 99% amylopectin, whereas regular corn contains about 72-76% amylopectin and 24-28% amylose. Amylopectin is a branched form of starch of high molecular weight, while amylose is a smaller unbranched or linear form of starch. Other starches can vary in their amylose contents. For example, rice starches can contain varying amounts of amylose. The amount and type of starch used can be adjusted to obtain the desirable level and type of crispiness. The amount of amylose in the starch component can be adjusted by adding amylose into the formula or by varying the ratios of starches with varying amylose content.

A variety of modified starches can also be used to create the desired coating texture. Starches are generally commercially available and methods for preparation of starches are described in U.S. Pat. Nos. 2,246,635 and 2,760,889. Modification to starches include degradation, crosslinking and etherification processes. Converted (degraded) starches are made by conversion that involves mainly a scission of the starch molecules to lower molecular weight fragments. When this is carried out on a granular starch, the granular structure is weakened and the granules tend to disintegrate more readily and more rapidly during the gelatinization process leading to a lower hot paste viscosity. Starch can also be converted by acid or enzyme conversion techniques. One particularly suitable modified starch for use in accordance with the invention is a tapioca-derived modified food starch available from National Starch and Chemical Corp., Bridgewater, N.J., under the trade name INSTANT-TEXTRA®. The INSTANT TEXTRA® product is cold water soluble and has resistance to gelling upon refrigeration, and has a molecular weight greater than about 10,000.

A process for making a modified starch product of the INSTANT TEXTRA® type starch is disclosed in U.S. Pat. No. 4,838,944, which is incorporated by reference herein. The patent discloses a process of degrading granular starch material with hydrogen peroxide and a catalytic amount of manganese in alkaline slurry to produce a modified food starch material. When in powder form, the modified starches suitable for the present invention typically have an average particle size in the range of from about 40 microns to about 60 microns, but may be of any other suitable particle size for incorporating into the food product. Another suitable starch is a pregelatinized modified high amylopectin food starch (e.g., BAKA-SNAK®, National Starch and Chemical Corp., Bridgewater, N.J.).

In embodiments, polysaccharides with branching are desirable. In a preferred embodiment, amylopectin which is a poly(1,4-alpha-D-glucan) with alpha-1→6 branching can be used. Another polysaccharide with branching is glycogen which has 1→6 branching for every 8-12 glucose units can be used. Generally polysaccharides with branching creating glycosidic bonds are desirable. In embodiments, starches that exhibit branching (e.g., amylopectin starch) are desired. Starches with high amylopectin content include the following waxy starches: waxy corn starch, waxy potato starch, waxy rice starch, waxy barley starch, waxy sorghum starch, waxy wheat starch and the like. In other embodiments, materials that can mimic the branched structure of starch may also be advantageously used. Such materials may be branched in structure or modified to perform like a branched material. For example, materials such as glycogen, cross linked and/or modified cellulose, CMC, MCC, HPMC, alginates, gelatin, chitosan, pectins, guar gum, gellan gum, glycolipids, locust bean gum, xanthan gum, carrageenans (kappa, lambda, iota), gum arabic, hydroxypropyl starches, hydrophobic starches, soy protein, whey protein, wheat protein, gluten, egg albumin, egg whites, chitosan, legume proteins, zein, hydrolyzed proteins and/or cross linked proteins, and the like, can be used.

In embodiments, high amylopectin starch and flour materials used to create surface-modifying particles may be moistened with water-based liquids or dispersed into oil and sprayed onto food substrate surfaces. This wettened mixture can adhere to the food product and is then set by baking. The mixture may be very viscous and moldable, to entirely coat a food substrate.

In embodiments, nucleating agents may be used to create sites for gas bubble formation. The use of nucleating agents may aid in increasing the number of air cells within the surface-modifying particles, therefore creating more surface texture. For example, sodium benzoate, talc, pigments, and/or calcium carbonate may be used as nucleating sites to produce air bubbles. In other embodiments, blowing agents may be used to form gas when heated (e.g., sodium bicarbonate with acid), thereby introducing desirable surface textures.

Once fully dispersed and/or dissolved, the coating mixture can be applied to a pre-weighed amount of a food product substrate, using techniques familiar to those of ordinary skill in the art, for example, spraying, tumbling, brushing, pouring, immersing, and the like. In embodiments, the coating mixture is added to the food substrate after it is cooked, for example to a flake breakfast food product after the drying/crisping step. In other embodiments, the coating mixture is added to the food substrate as part of the processing step, halfway through cooking for example. In embodiments, suitable food product substrates can include substances such as the surfaces of breakfast food products, vegetable and potato chips, crackers, granola bars, pretzels, dried fruit, nuts, cookies and breads, and the like. The food product substrates may be formed as puffs, flakes, chips, formed products or any other suitable shape and size for the application of a particulate flavoring coating. In other embodiments, suitable food product substrates can include substances such as meats, fish, poultry, cheese, dairy (yogurt, ice cream, etc.), legume products (e.g., tofu), protein preparations, tempura prepared foods (e.g., meats, seafood and vegetable), bakery food products (pie crusts, breads, cookies, etc.) vegetables (potatoes, sweet potatoes, yams, onions, etc.), fruits and granola bars.

After the coated food product substrate has attained the requisite degree of tackiness, the selected particulate (e.g., flavoring(s) or edible surface-modifying particles), can be added to the coated food product substrate by tumbling, inclusion dusting, sprinkling, and the like, with or without heat, depending upon on the mixture composition and properties. Particulates can be added and tumbled with the food product substrate either immediately after initial coating has been applied, or after tackiness has been induced through heat addition and water loss. Amount of particulate to be added can be determined using methodologies familiar to those of ordinary skill in the art, including evaluation of the amount of flavor provided by a given additive, the caloric content of the additive, the desired textural properties, and the like. When there has been adequate adherence of particulate flavoring to the coated food product substrate, heat may be added to set the coating. For example, this can be completed with a conveyer, tray, and/or convection heating/drying system. Or, as another example, the coating mixture can be applied to the surfaces of the food product substrate with an enrober or sprayer on a conveyor system. As the coated food product substrate passes along the conveyor system, particulate flavoring can be applied at a separate station. The conveyor system can then transport the coated complex into a convection oven or other heating/drying system.

In an embodiment, the particulate flavoring(s) can be dispersed into the coating mixture and then applied to the food surface using one of the means described above. In yet another embodiment, the coating mixture can be applied to the particles to coat them using a means such as precipitation, dip coating, or spray-on. The coated particles can then be attached to the surfaces of the food product substrates while the coating material is still tacky. Alternatively, the coated particles can be treated, e.g., by wetting or heating, to make them tacky so that they adhere to the food product substrate.

In an embodiment an edible surface-modifying particle coating can be adhered to food substrate surfaces using an edible adhesive or using the intrinsic moisture content and surface moisture of the food substrate to cause adherence. Substrates may include but are not limited to: meat products (steak, pork, hot dogs, etc.), poultry (chicken—tenders, nuggets, patties, etc.), fish (fish sticks, pollock, haddock, flounder, yellowtail, salmon, cod, etc.), cheese (mozzarella and cheese sticks), vegetables (potatoes, sweet potatoes, yams, onions, mushrooms, zucchini, eggplant, etc.), legume products (tofu, etc.), dairy products, baked goods, or combinations thereof, for example, a prepared meal or a dessert. Edible surface-modifying particle coatings for substrates may vary in particulate size and contain a variety of sizes to alter texture of the final product.

As would be understood by those of ordinary skill in the art, the compositions and methods disclosed herein that provide for edible texture-modifying coatings can be combined with other texture-enhancers or flavor enhancers. For example, edible surface-modifying particles can be flavored with a variety of flavors, including flavors in liquid or powdered or particulate form, and including water or oil-based flavors. Spices (e.g., parsley, oregano, rosemary, thyme, and the like), salt, natural or artificial flavors (vinegar, barbeque, jalapeno, cinnamon, guacamole, honey, catsup, shoyu, wasabi, butter, mustard, beer, bacon, soy sauce, teriyaki, maple syrup, fried flavor, ranch, etc.), aromas (mesquite, coconut, cinnamon, etc.) and flavoring particulates (sugar, garlic, onion, pepper, vegetables, chocolate, coconut, fruits, etc.) may be included in the preparation, for example, by being incorporated into adhesive batter or uncooked precursor material before baking or post baking.

In a preferred embodiment, a composition comprises the components listed in Table I and in the amounts listed in Tables I-III:

TABLE I

| Ingredient | Dry Weight (%) |
|---|---|
| Pregelatinized Waxy Corn Starch | 30-50% or 35-45% |
| Pregelatinized Rice Starch | 0-10% or 4-8% |
| INSTANT-TEXTRA ® (Modified, | 0-20% or 5-15% |
| Pregelatinized Tapioca Starch) | |
| Pregelatinized Corn Meal | 20-70% or 30-50% |
| Salt | 0-10% or 2-7% |

TABLE II

| Ingredient | Dry Weight (%) |
|---|---|
| Pregelatinized Waxy Corn Starch | 30-50% or 35-45% |
| Pregelatinized Rice Starch | 5-20% or 12-18% |
| Pregelatinized Corn Meal | 20-70% or 30-50% |
| Salt | 0-10% or 2-7% |

TABLE III

| Ingredient | Dry Weight (%) |
|---|---|
| Pregelatinized Waxy Corn Starch | 30-50% or 35-45% |
| Pregelatinized Rice Starch | 3-10% or 4-8% |
| Pregelatinized Waxy Potato Starch | 5-20% or 7-12% |
| Pregelatinized Corn Meal | 20-70% or 30-50% |
| Salt | 0-10% or 2-7% |

The compositions of Tables I-III may further contain ingredients such as water, spices, sweeteners and edible colors. In embodiments, the amount of salt can be varied in accordance with taste preferences.

### EXAMPLES

The following examples are provided to illustrate some aspects of the present application. The examples, however, are not meant to limit the practice of any embodiment of the invention. For example, the amounts of component ingredients in the formulation can be modified in order to achieve various advantageous properties. For example, the relative amounts of the component starches can be adjusted to produce a different texture, for example by adding more potato starch or less rice starch to the formulation to create a lighter, more airy product.

Moreover, as would be understood by those of ordinary skill in the art, the processes described in the following examples can be scaled up onto production-size equipment. A rotating drum may be particularly advantageous for applying the coating mixture, as it provides the option of applying heat during the application process to drive out excess water and aid in crisping the food product. If further heating and/or crisping is desired and also for setting the coating, for example, the coated product can be conveyed into a convection chamber or an oven.

As would be further understood by those of ordinary skill in the art, the processes described below are suitable for use on a variety of substrates, some of which have been enumerated above (e.g., carbohydrate substrates such as potatoes, yams, onions, breads, etc., protein substrates such as fish, poultry, meat, tofu, etc.). Disclosed herein are several embodiments of edible surface-modifying particle preparations, further disclosed are two embodiments of edible adhesives for adhering the edible surface-modifying particle preparations to the substrates. As would be understood by those of ordinary skill, various combinations of substrates, edible surface-modifying particles and edible adhesives can be employed in keeping with the principles of the invention, as illustrated by some of the examples below. As would be further understood by those of ordinary skill in the art, the substrates, edible surface-modifying particle preparations and/or adhesives used in accordance with the disclosed systems and methods can be modified by using conventional techniques to improve flavor or texture (e.g., by brining meats before using, or including flavoring materials to either the adhesive or to the edible surface-modifying particles as described above).

### Example 1

### Edible Surface-Modifying Particle Coating, Containing Modified Tapioca Starch

TABLE 1

| Ingredient | Amount (wt %) | Dry Weight (%) |
|---|---|---|
| Pregelatinized Waxy Corn Starch | 21.07% | 41.67% |
| Pregelatinized Rice Starch | 3.01% | 5.95% |
| INSTANT-TEXTRA ® (Modified, | 5.14% | 10.16% |
| Pregelatinized Tapioca Starch) | | |
| Pregelatinized Corn Meal | 19.84% | 39.23% |
| Salt | 1.51% | 2.99% |
| Water | 49.43% | |
| TOTAL | 100.00% | |

Ingredients listed in Table 1 were used in this Example. All dry ingredients (starches and meal) were combined together and blended until homogenous. Water was poured into a stand mixer (KITCHENAID® mixer) with a paddle attachment and the dry mixture was slowly added to the water while mixing on medium-high speed. To prevent dusting off, approximately 25% of the total amount being added slowly to the mixture until all of the dry ingredients were included. The edible surface-modifying particle precursor material was allowed to mix until homogeneous; approximately an additional 5 minutes once the last amount of dry ingredient was thoroughly mixed. Once the edible surface-modifying particle precursor was finished mixing it was rolled into flat sheets. The flat sheets were baked at 350° F. in a convection oven (Cadco, LTD—Model XA006) for 25 minutes total. A flat, puffed-cracker-like material was formed having a frangible consistency. This material was allowed to cool, and was then milled into various sized particulates (crumbs) using a burr grinder. Preferred particulate size ranged from 0.2 mm-1.2 mm, but smaller or larger particulates may be created depending on the type of use (e.g., larger crumbs or flakes, like panko style crumbs in size and shape). The water activity of the final product ranged between 0.05-0.2, and the particles appeared yellow and glassy.

### Example 2

### Adhesive Surface Coating, Containing Modified Starch

TABLE 2

| Ingredient | Amount (wt %) | Dry Weight (%) |
|---|---|---|
| Pregelatinized Waxy Corn Starch | 5.72% | 41.63% |
| Pregelatinized Rice Starch | 0.82% | 5.97% |
| INSTANT-TEXTRA ® (Modified, | 1.40% | 10.19% |
| Pregelatinized Tapioca Starch) | | |
| Pregelatinized Corn Meal | 5.39% | 39.23% |
| Salt | 0.41% | 2.98% |
| Water | 86.26% | |
| TOTAL | 100.00% | |

Ingredients listed in Table 2 were used in this Example. First, all dry ingredients (starches and meal) were combined together and blended until homogeneous. Water was poured into a KITCHENAID® mixer with the whisk attachment, and the dry mixture was slowly added to the water while whisking on medium-high speed, with approximately 25% of the total amount being added every few minutes to the mixture until all of the dry ingredients were included. The mixture was whisked for an extra 10 minutes on high speed after the final amount of dry ingredient was included. The resulting material was a lightly viscous liquid suitable for use as an adhesive for attaching food particulates onto food substrates.

### Example 3

### Preparation of Particulate Coated, Baked Chicken Tenderloin

Samples of edible surface-modifying particle coating and edible adhesive coating prepared according to the methods set forth in Examples 1 & 2. For this Example, convection oven heating was used, with a convection oven (Cadco, LTD—Model XA006) being preheated to 350° F. A baking sheet was coated with parchment paper and sprayed with a thin layer of canola oil. Raw chicken tenderloins were prepared and coated with a thin layer of the edible adhesive coating (batter) by dipping the entire chicken piece into a container filled with batter. The batter was slightly viscous, similar to the appearance and viscosity of an egg wash but milky in color. A thin layer of adhesive batter was coated on to the chicken tenderloin piece. The adhesive batter coated chicken was then rolled in an edible surface-modifying particle coating prepared in accordance with Example 1 until fully coated, with the edible surface-modifying particles being attached to the substrate via the edible adhesive. The fully coated chicken piece was placed onto the oiled parchment paper. After the edible surface-modifying particle coating was applied as described above, the chicken samples were sprayed with a thin layer of canola oil for added taste and placed into the oven. In each experiment, the coated chicken samples were baked for a total of 20 minutes (until reaching an internal temperature 165° F.); they were flipped over half way through cooking. Once fully cooked, the chicken was taken out of the oven and cooled in a refrigerator before putting into a conventional freezer to be frozen solid.

### Example 4

### Reconstitution of Particulate Coated, Baked and Frozen Chicken Tenderloin

Fully baked, coated, frozen chicken tenderloins prepared in accordance with Example 3 were reconstituted using a convection oven, and were reconstituted using a microwave oven. For one experiment, particulate coated chicken tenderloins prepared in accordance with Example 3 were placed into a convection oven (Cadco, LTD—Model XA006) that had been preheated to about 400° F. The frozen particulate-coated chicken tenderloin was baked for approximately 15 minutes, until hot and crispy. In another experiment, microwave oven heating was used to reconstitute particulate-coated chicken tenderloins prepared in accordance with Example 3. For this experiment, samples of the frozen particulate-coated chicken tenderloins were put into susceptor packaging (sleeve) and microwaved (1300 W microwave Panasonic Inverter), for 1 minute and 30 seconds total (1 minute at medium-power and 30 seconds at high power). The resulting pieces of chicken had an even coating of particulate material and exhibited mostly crispy surface characteristics with mostly moist internal flesh after reconstitution.

### Example 5

### Particulate Coated Flounder

Samples of edible surface-modifying particle coating and edible adhesive coating prepared according to the methods set forth in Examples 1 & 2. Raw flounder filet pieces were coated with batter surface coating from Example 2 and then rolled in edible surface-modifying particle coating from Example 1. A convection oven (Cadco, LTD—Model XA006) was preheated to 350° F. and a cooling rack on top of a baking sheet was prepared. For each experiment, the coated fish was placed on top of the cooling rack and baked for approximately 20 minutes until fully cooked. The flounder was cooled in a refrigerator before putting into a conventional freezer to be frozen solid.

### Example 6

### Reconstitution of Particulate Coated, Baked and Frozen Flounder

Fully baked, particulate-coated frozen flounder prepared in accordance with Example 5 was reconstituted in a convection oven or microwave. A convection oven (Cadco, LTD—Model XA006) was preheated to 400° F. and the samples of the frozen particulate-coated flounder were cooked for approximately 15 minutes, until hot and crispy. In another experiment, a microwave oven was used to reconstitute the samples. For this experiment, samples of frozen-particulate coated flounder were put into susceptor packaging (sleeve) and microwaved (1300 W microwave Panasonic Inverter). Each sample was microwaved for 1 minute and 30 seconds total (1 minute at medium-power and 30 seconds at high power). The resulting pieces of flounder had an even coating of particulate material and exhibited mostly crispy surface characteristics with a mostly moist internal flesh after reconstitution.

### Examples 7

### Edible Surface-Modifying Particle Coating, without Modified Tapioca Starch

TABLE 3

| Ingredient | Amount (wt %) | Dry Weight (%) |
|---|---|---|
| Pregelatinized Waxy Corn Starch | 21.07% | 41.67% |
| Pregelatinized Rice Starch | 8.15% | 16.11% |
| Pregelatinized Corn Meal | 19.84% | 39.23% |
| Salt | 1.51% | 2.99% |
| Water | 49.43% | |
| TOTAL | 100.00% | |

The ingredients listed in Table 3 were combined as described in Example 1. The sample prepared in this Example does not contain modified tapioca starch.

### Example 8

### Adhesive Surface Coating, without Modified Tapioca Starch

TABLE 4

| Ingredient | Amount (wt %) | Dry Weight (%) |
|---|---|---|
| Pregelatinized Waxy Corn Starch | 5.72% | 41.63% |
| Pregelatinized Rice Starch | 2.22% | 16.16% |
| Pregelatinized Corn Meal | 5.39% | 39.23% |
| Salt | 0.41% | 2.98% |
| Water | 86.26% | |
| TOTAL | 100.00% | |

The ingredients listed in Table 4 were combined as described in Example 2. The sample prepared in this Example does not contain modified tapioca starch.

### Example 9

### Particulate Coated Chicken Tenderloin

Chicken tenderloins were prepared in the same manner as in Example 3, using the edible surface-modifying particle coating from Example 7 and edible surface adhesive coating from Example 8.

### Example 10

### Reconstitution of Particulate Coated, Baked and Frozen Chicken Tenderloin

Chicken tenderloins were reconstituted in the same manner as in Example 4. The resulting piece of chicken was crispy in some areas and mostly moist.

### Example 11

### Particulate Coated Cod and Mahi-Mahi

Both cod and mahi-mahi pieces were coated and prepared in the same manner as the flounder in Example 5, using edible surface-modifying particle coating from Example 7 and surface adhesive coating from Example 8.

### Example 12

### Reconstitution of Particulate-Coated, Baked and Frozen Cod and Mahi-Mahi

Both cod and mahi-mahi were reconstituted in the same manner as in Example 6. The resulting cod pieces exhibited a mostly crisp coating on top. The resulting mahi-mahi pieces exhibited a mostly crispy coating with a moist center.

### Example 13

### Edible Surface-Modifying Particle Coating, with Pregelatinized Potato Starch

TABLE 5

| Ingredient | Amount (wt %) | Dry Weight (%) |
|---|---|---|
| Pregelatinized Waxy Corn Starch | 21.07% | 41.67% |
| Pregelatinized Rice Starch | 3.01% | 5.95% |
| Pregelatinized Waxy Potato Starch | 5.14% | 10.16% |
| Pregelatinized Corn Meal | 19.84% | 39.23% |
| Salt | 1.51% | 2.99% |
| Water | 49.43% | |
| TOTAL | 100.00% | |

The ingredients listed in Table 5 were combined as described in Example 1. The sample prepared in this Example contains pregelatinized potato starch and does not contain any modified tapioca starch.

### Example 14

### Preparation of Baked Potato Strips with Edible Surface-Modifying Particles

The edible surface-modifying particle coating formulation from Example 13 was used for this example. Fresh potatoes (Russet and Yukon Gold) were peeled and cut into ⅓ and ½ inch strips and submerged in water until time of use. Soaked potato strips were allowed to remain moist and damp. Edible surface-modifying particle coating formulation, prepared in accordance with Example 13 was applied to the damp potato strips by rolling. It was observed that the edible surface-modifying particle coating would affix to the wet surfaces of the potato substrate without need for a surface adhesive. The strips were rolled in edible surface-modifying particle coating until fully coated.

A convection oven (Cadco, LTD—Model XA006) was preheated to 400° F. A baking sheet was prepared with a piece of parchment paper sprayed with a thin layer of canola oil. For each sample, coated potato strips were placed on the prepared baking sheet, sprayed lightly with canola oil and put in the oven for a total of 10-15 minutes. It was determined to be advantageous to undercook the potato strips to allow for the reheating step described below in Example 15 to fully cook the potato. The cooked potato strips were cooled off in the refrigerator and then put into a conventional freezer for freezing until frozen solid.

### Example 15

### Reconstitution of Frozen, Coated Potato Strips with Edible Surface-Modifying Particles

Partially-baked or fully-baked edible surface-modifying particle-coated frozen potato strips prepared in accordance with Example 14 were reconstituted as follows. For one experiment, a convection oven (Cadco, LTD—Model XA006) was preheated to 400° F. and frozen potato strips prepared in accordance with Example 14 were baked for approximately 10 minutes. In another experiment, frozen potato strips prepared in accordance with Example 14 were reconstituted in a microwave. For this experiment, the frozen potato strips were put into susceptor packaging and microwaved (Panasonic Inverter 1300 W) for approximately 40-60 seconds, or until the outside was crispy. It was determined that the optimal time for microwave cooking varied based on the amount of fries cooked and the sensitivity of the microwave. When baked or microwaved, the samples prepared for this Example exhibited a “crunch” noise audible to the taste-tester when bitten into.

### Example 16

### Preparation of Onion Rings with Edible Surface-Modifying Particles

Edible surface-modifying particle coating from Example 13 was used in this example. A raw sweet onion was cut into 1 inch thick rings. Some onion rings were coated with a thin layer of canola oil and some were coated with adhesive coating from Example 8. Both samples were then rolled in the edible surface-modifying particle coating as prepared in Example 13 until fully coated and placed on a baking sheet. Samples coated with adhesive coating had more edible surface-modifying particle matter attached than the samples coated only with canola oil. A convection oven (Cadco, LTD—Model XA006) was preheated to 400° F. Onion rings bearing the edible surface-modifying particle coating (both with and without the use of adhesive coating) were cooked for 10 minutes. The cooked onion rings were cooled off in the refrigerator and then put into a conventional freezer for freezing until frozen solid.

### Example 17

### Reconstitution of Frozen, Cooked Onion Rings with Edible Surface-Modifying Particulates

Edible surface-modifying particle coated, cooked, frozen onion rings prepared in accordance with Example 16 were reconstituted as follows. A convection oven (Cadco, LTD—Model XA006) was preheated to 400° F. and frozen onion rings prepared in accordance with Example 16 were baked for approximately 6 minutes. Resulting onion rings had a crispy coating while the onion substrate remained tender. In another experiment, frozen onion rings prepared in accordance with Example 16 were reconstituted in a microwave. For this experiment, the frozen onion rings were put into susceptor packaging and microwaved (Panasonic Inverter 1300 W) for approximately 40-60 seconds, or until the outside was mostly crispy. It was determined that the optimal time for microwave cooking varied based on the amount of onion rings cooked and the sensitivity of the microwave. When baked or microwaved, the samples prepared for this Example exhibited a “crunch” noise audible to the taste-tester when bitten into.

### Example 18

### Preparation of Baked Yam Strips with Crispy Particulates

Edible surface-modifying particle coating formulation from Example 13 was used for this example. Fresh yams were peeled, cut to ½ inch strips and soaked in water until read for use. Soaked yam strips were allowed to remain moist and damp. Edible surface-modifying particle coating formulation, prepared in accordance with Example 13 was applied to the damp yam strips by rolling. It was observed that the edible surface-modifying particle coating would affix to the wet surfaces of the yam substrate. The strips were rolled in edible surface-modifying particle coating until fully coated.

A convection oven (Cadco, LTD—Model XA006) was preheated to 400° F. A baking sheet was prepared with a piece of parchment paper sprayed with a thin layer of canola oil. For each sample, edible surface-modifying particle-coated yam strips were placed on the prepared baking sheet, sprayed lightly with canola oil and put in the oven for a total of 10 minutes. The cooked yam strips were cooled off in the refrigerator and then put into a conventional freezer for freezing until frozen solid.

### Example 19

### Reconstitution of Frozen, Cooked Yam Strips with Edible Surface-Modifying Particulate Coating

Edible surface-modifying particle coated, cooked, frozen yam strips prepared in accordance with Example 18 were reconstituted as follows. A convection oven (Cadco, LTD—Model XA006) was preheated to 400° F. and frozen yam strips prepared in accordance with Example 18 were baked for approximately 10 minutes. In another experiment, frozen yam strips prepared in accordance with Example 18 were reconstituted in a microwave. For this experiment, the frozen yam strips were put into susceptor packaging and microwaved (Panasonic Inverter 1300 W) for approximately 40-60 seconds, or until the outside was crispy. It was determined that the optimal time for microwave cooking varied based on the amount of yam strips cooked and the sensitivity of the microwave. When baked or microwaved, the samples prepared for this Example exhibited a “crunch” noise audible to the taste-tester when bitten into.

### Example 20

### Edible Surface-Modifying Particle Coating Made in Larger Batches

The dry ingredients were combined together in an enclosed tumble mixer at 100 pound batches for 4 minutes to ensure a homogeneous mixture. Seventeen pounds of dry material was combined with water in a 30 quart planetary mixer and mixed for 15 minutes or until fully incorporated. The resulting sticky, viscous edible surface-modifying particle precursor was hand sheeted into 1/16-⅛″ thick sheets onto vented ½ sheet pans. Dough sheets were baked in a convection oven at 375° F. for around 22 minutes and rotated after 11 minutes. Some sheets needed to bake for a longer period of time due to uneven sheeting and returned into the oven until fully crisp. Sheets were allowed to cool and were then crushed using a Cusinart food processor. Crushed cracker pieces were then ground with a grain mill attachement from a KITCHENAID® mixer to the desired particle size. The resulting water activity of the finished product was 0.155.

TABLE 6A

| Ingredient | Amount (wt %) | Dry Weight (%) |
|---|---|---|
| Pregelatinized Waxy Corn Starch | 20.76% | 40.07% |
| Pregelatinized Rice Starch | 2.97% | 5.73% |
| Pregelatinized Waxy Potato Starch | 5.07% | 9.9% |
| Pregelatinized Corn Meal | 19.55% | 37.73% |
| Salt | 3.46% | 6.68% |
| Water | 48.19% | |
| TOTAL | 100.00% | |

The formulation set forth above in TABLE 6A has amounts of native pregelatinized high amylose corn starch (HACS), pregelatinized high amylopectin corn starch (HAPCS), pregelatinized waxy potato starch (PS), pregelatinized rice starch (RS), pregelatinized corn meal (CM), and salt. The % amylose (% A) and % amylopectin (% AP) ratios, all calculated considering only the starch containing inclusions in the formula (e.g., excluding salt), on a dry basis (DB). Please note % A +% AP=100%, all as listed below in TABLE 6B.

TABLE 6B

| | % | % | | | | % | | |
|---|---|---|---|---|---|---|---|---|
| Formula | HACS | HAPCS | % PS | % RS | % CM | Salt | % A | % AP |
| Table 6 | 0 | 40.07 | 9.79 | 5.73 | 37.73 | 6.68 | 11.75 | 88.25 |

### Example 21

### Preparation of Potato Wedges and Strips Made with Edible Surface-Modifying Particulate Coating

Wedges were cut from medium sized Russet Burbank potatoes, eight wedges per potato and put into a container of water. Strips were sliced into ⅜″ pieces and also put into a container of water. Soaked potato wedges and strips were allowed to remain moist. Edible surface-modifying particle coating formulation, prepared in accordance with Example 20 was applied to the damp potato wedges and strips by rolling/tumbling. A convection oven (Cadco, LTD—Model XA006) was preheated to 375° F. A baking sheet was prepared with a piece of parchment paper. Coated, raw potato wedges were placed onto the prepared baking sheet and baked for a total of 11 minutes. Coated, raw potato strips were placed onto the prepared baking sheet and baked for a total of 10 minutes. The wedges and strips were then allowed to cool and were put into a conventional freezer until frozen.

### Example 22

### Reconstitution of Frozen, Coated Potato Wedges and Strips with Edible-Surface Modifying Particles

Frozen potato wedges and strips prepared in accordance with Example 21 were reconstituted as follows. A convection oven (Cadco, LTD—Model XA006) was preheated to 375° F. and frozen potato wedges prepared in accordance with Example 21 were baked for 15 minutes or until golden in color. Frozen potato strips prepared in accordance with Example 21 were baked for 10-11 minutes, or until golden in color. The resulting baked potato wedges and strips were golden and crispy with a moist, baked potato like center.

### Example 23

### Starch Ratio Experiments

Starch (amylose and amylopectin) ratios are based on starch containing components (starches, flours, meals, etc.) within the formulation. Addition of non-starch containing ingredients (e.g., proteins, fats, insoluble particulates, etc.) may cause the ideal starch ratio and preferable range to change to accommodate the ingredient additions. The following formulations each contain various amount of native pregelatinized high amylose corn starch (HACS), pregelatinized high amylpectin corn starch (HAPCS), pregelatinized waxy potato starch (PS), pregelatinized rice starch (RS), pregelatinized corn meal (CM), and salt. The % amylose (% A) and % amylopectin (% AP) ratios in the entire formula were calculated considering only the starch containing inclusions in the formula (e.g., excluding salt), on a dry basis (DB). Please note % A+% AP=100%.

The following formulations in TABLE 7 produced unacceptable finish product when the coatings were used to coat potato products. The finished product was soggy and not crisp enough. The resulting coating was chewy, not cohesive and powdery.

TABLE 7

| | % | % | | | | % | | |
|---|---|---|---|---|---|---|---|---|
| Formula | HACS | HAPCS | % PS | % RS | % CM | Salt | % A | % AP |
| A | 93.32 | 0 | 0 | 0 | 0 | 6.68 | 70.00 | 30.00 |
| B | 74.02 | 0 | 0 | 0 | 19.30 | 6.68 | 60.69 | 39.31 |

The following formulations in TABLE 8 produced acceptable finished product when the coatings were used to coat potatoes, and it was determined that they yielded different results than the formulations in TABLE 9. Using the TABLE 8 formulations, the resulting finished products were crispy, but with a more granular, rough surface coat (rather than a cohesive or smooth coat that adheres well to the substrate). These formulations may be preferable for those substrates that are effectively treated with a batter process.

TABLE 8

| | % | % | | | | % | | |
|---|---|---|---|---|---|---|---|---|
| Formula | HACS | HAPCS | % PS | % RS | % CM | Salt | % A | % AP |
| C | 56.21 | 8.16 | 0 | 0 | 28.95 | 6.68 | 50.00 | 50.00 |
| D | 48.48 | 15.88 | 0 | 0 | 28.95 | 6.68 | 44.29 | 55.71 |
| E | 38.83 | 25.54 | 0 | 0 | 28.95 | 6.68 | 37.16 | 62.84 |
| F | 29.18 | 35.19 | 0 | 0 | 28.95 | 6.68 | 30.02 | 69.98 |
| G | 17.39 | 32.6 | 0 | 0 | 42.49 | 7.52 | 25 | 75 |
| H | 22.39 | 41.98 | 0 | 0 | 28.95 | 6.68 | 25 | 75 |
| I | 0 | 0 | 0 | 0 | 93.22 | 6.68 | 25 | 75 |

The following formulations in TABLE 9 produced the best results on finish product when the coatings were used to coat potatoes. The resulting finished products produced a crispy, granular skin on the substrate and had the look of a fried product post reconstituting.

TABLE 9

| | % | % | | | | % | | |
|---|---|---|---|---|---|---|---|---|
| Formula | HACS | HAPCS | % PS | % RS | % CM | Salt | % A | % AP |
| J | 14.09 | 50.28 | 0 | 0 | 28.95 | 6.68 | 18.86 | 81.14 |
| K | 0 | 0 | 49.86 | 5.73 | 37.73 | 6.68 | 11.75 | 88.25 |
| L | 0 | 49.86 | 0 | 5.73 | 37.73 | 6.68 | 11.75 | 88.25 |
| M | 4.44 | 59.93 | 0 | 0 | 28.95 | 6.68 | 11.73 | 88.27 |
| N | 0 | 37.01 | 37.01 | 0 | 19.3 | 6.68 | 5.96 | 94.04 |
| O | 0 | 46.66 | 46.66 | 0 | 0 | 6.68 | 1.00 | 99.00 |

### Example 24

### Preparation of Pre-Fried, Frozen Potatoes and Coated with Edible Surface Modifying Particulates

Pre-fried, frozen french fries were sprayed with enough water to dampen the surface and then tumbled with edible surface modifying particulates as prepared in accordance with Example 20 until fully coated. The still mostly frozen, coated french fries were allowed to fully freeze. Frozen fries were put into a susceptor film coated box and reconstituted via microwaving. The fries were microwaved (1300 W microwave Panasonic Inverter) for approximately 4 minutes on high power. They were allowed to sit for 30 seconds after microwaving before tasting. Fries were very crispy in comparison to soggy control fries, not coated with edible surface-modifying particulates and cooked with the same methodology. Coated french fries were allowed to cool fully to room temperature and then were reheated in the microwave for one minute in a susceptor film coated box. The coated fries were notably crispy post reheating.

While this invention has been particularly shown and described with references to preferred embodiments thereof, it will be understood by those skilled in the art that various changes in form and details may be made therein without departing from the scope of the invention encompassed by the appended claims.

1. An edible surface-modifying particle precursor composition for preparing edible surface-modifying particles, comprising:
a. one or more polysaccharides wherein about 80 to about 100% of said polysaccharides have branching, wherein said branched polysaccharides is about 25 to about 75% of the dry weight of the composition; and
b. a grain meal wherein said grain meal is about 25 to about 75% of the dry weight of the composition.

2. The edible surface-modifying particle precursor composition of claim 1, wherein said one or more polysaccharides comprises amylopectin.

3. The edible surface-modifying particle precursor composition of claim 2, wherein said polysaccharides comprise about 80 to about 100% amylopectin.

4. The edible surface-modifying particle precursor composition of claim 1, wherein said one or more polysaccharide comprise about 0 to about 20% amylose and about 80 to about 100% amylopectin.

5. An edible surface-modifying particle precursor composition for preparing edible surface-modifying particles, comprising:
a. one or more starches resulting in a total amylose content from about 0.1% to about 20% of the dry weight of the starch-containing components of the composition; and
b. a cereal comprising about 10% to about 70% of the dry weight of the composition.

6. The edible surface-modifying particle precursor composition of claim 5, wherein said cereal is a pregelatinized ground cereal.

7. The surface-modifying particle precursor composition of claim 6, wherein said pregelatinized ground cereal is selected from pregelatinized corn, barley, wheat, rye and oats, or a combination thereof.

8. The edible surface-modifying particle precursor composition of claim 1, further comprising water.

9. An edible surface-modifying particle precursor composition for preparing edible surface-modifying particles, comprising:
a. one or more starches resulting in a total amylose content from said one or more starches of about 0.1% to about 20% of the total weight of the composition;
b. a ground cereal comprising about 10% to about 40% of the total weight of the composition; and
c. water.

10. The composition of claim 9, wherein said one or more starches comprise about 10% to about 40% of the total weight of the composition.

11. The composition of claim 9, wherein said one or more starches comprise about 25% to about 35% of the total weight of the composition.

12. The composition of claim 9, wherein said total amylose content from said one or more starches ranges from about 0.5% to about 10% of the total weight of the composition.

13. The composition of claim 9, wherein said total amylose content from said starches ranges from about 0.8% to about 3.0% of the total weight of the composition.

14. The composition of claim 9, wherein said total amylose content from said starches ranges from about 0.8% to about 3.0% of the total weight of the composition.

15. The composition of claim 9, wherein each of said one or more starches is made from rice, barley, wheat, potato, tapioca, or corn or a combination thereof.

16. The composition of claim 9, wherein said one or more starches is a mixture of corn starch, rice starch and converted tapioca starch.

17. The composition of claim 14, wherein said one or more starches is a mixture of corn starch, rice starch and converted tapioca starch.

18. The composition of claim 14, wherein at least one of said one or more starches is pre-cooked or pregelatinized.

19. The composition of claim 9, wherein said ground cereal is selected from the group consisting of corn meal, cream of wheat, ground barley and ground oats.

20. The composition of claim 9, wherein said ground cereal pre-cooked or pregelatinized.

21. The composition of claim 9 having a total amylose content from starch and ground cereal of about 5% to about 20% of the total weight of the composition.

22. The composition of claim 9 having a total amylose content from starch and ground cereal of about 10% to about 15% of the total weight of the composition.

23. The composition of claim 14 having a total amylose content from starch and ground cereal of about 10% to about 15% of the total weight of the composition.

24. A composition for preparing edible surface-modifying particles comprising:
a. waxy corn starch in an amount of about 10% to about 40% of the total weight of the composition;
b. rice starch in an amount of about 1.0% to about 10% of the total weight of the composition;
c. converted tapioca starch in an amount of about 1.0% to about 10% of the total weight of the composition;
d. corn meal in an amount of about 10% to about 30% of the total weight of the composition; and
e. water.

25. The composition of claim 24, wherein at least one of waxy corn starch, rice starch, converted tapioca starch or corn meal is pregelatinized.

26. The composition of claim 24, comprising:
a. pregelatinized waxy corn starch in an amount of about 10% to about 40% of the total weight of the composition;
b. pregelatinized rice starch in an amount of about 1.0% to about 10% of the total weight of the composition;
c. pregelatinized converted tapioca starch in an amount of about 1.0% to about 10% of the total weight of the composition;
d. pregelatinized corn meal in an amount of about 10% to about 30% of the total weight of the composition; and
e. water.

27. A food product coated with the edible surface-modifying particle precursor composition of claim 1.

28. An edible surface-modifying particulate composition prepared by heating the edible surface-modifying particle precursor composition from claim 1.

29. The edible surface-modifying particle composition of claim 28, wherein the edible surface-modifying particle precursor composition is heated to a low moisture state.

30. The edible surface-modifying particle composition of claim 28 having a water activity is between about 0.2 to about 0.9, or about 0.2 and about 0.7.

31. The edible surface-modifying particle composition of claim 30 having a water activity that is between about 0.25 and about 0.7 or between about 0.25 and about 0.6 or between about 0.3 and about 0.5.

32. A coated food substrate comprising:
a. a raw, partially cooked or fully cooked food substrate; and
b. a coating of edible surface-modifying particle composition of claim 19.

33. The coated food substrate of claim 32, wherein said food substrate is raw meat.

34. The coated food substrate of claim 33, wherein said raw meat is selected from the group consisting of chicken, beef, lamb, goat, duck, pork, buffalo and venison.

35. The coated food substrate of claim 32, wherein said food substrate is fish.

36. The coated food substrate of claim 35, wherein said fish is selected from the group consisting of salmon, flounder, haddock, tuna, catfish, trout, bass, mahi-mahi, sardines, perch, mackerel, tilapia, sole, pearlspot, butterfish, pomfret, carp, pollack, hake and cod.

37. The coated food substrate of claim 32, wherein said food substrate is a partially cooked.

38. The coated food substrate of claim 32, wherein said food substrate is a processed meat product.

39. The coated food substrate of claim 32, wherein said food substrate is a vegetable or a combination of vegetables or an edible food without meat.

40. The coated food substrate of claim 32, wherein said food substrate is selected from potato strips, baked yam strips and baked potato strips.

41. A frozen edible surface-modifying particle coated food product wherein a coated food substrate of claim 32 is frozen.

42. An edible adhesive composition comprising:
a. one or more starches resulting in a total amylose content from said starches of about 0.01% to about 10% of the total weight of the composition;
b. a ground cereal or a combination of ground cereals comprising about 1% to about 20% of the total weight of the composition; and
c. water.

43. The edible adhesive composition of claim 42, wherein said one or more starches are selected from pregelatinized waxy corn starch, pregelatinized rice starch, modified tapioca starch, pregelatinized barley starch and combinations thereof.

44. The edible adhesive composition of claim 42, wherein said ground cereal is selected from the group consisting of pregelatinized corn meal, pregelatinized ground barley, wheat, rye and oats, or a combination thereof.

45. The edible adhesive composition of claim 42, wherein said amylose is between about 0.1% to about 10% of the total weight of the composition.

46. The edible adhesive composition of claim 42, wherein said amylose is between about 0.2% to about 3% of the total weight of the composition.

47. The edible adhesive composition of claim 42, wherein said ground cereal is between about 3% to about 10% of the total weight of the composition.

48. The edible adhesive composition of claim 42, wherein said ground cereal is between about 4% to about 7% of the total weight of the composition.

49. The composition of claim 1, further comprising salt.

50. The composition of claim 1, further comprising a plasticizer.

51. The composition of claim 1, wherein said one or more starches consist essentially of a combination of about 5% pregelatinized waxy corn starch, about 0.8% pregelatinized rice starch and about 1.4% modified pregelatinized tapioca starch.

52. The composition of claim 42, wherein said ground cereal is about 5% corn meal.

53. The composition of claim 42, further comprising a plasticizer.

54. The composition of claim 53, wherein said plasticizer is selected from glycol, glycerol, erythritol, arabitol, xylitol, sorbitol, mannitol, maltitol, isomalt, polyglycitol, threitol and a combination thereof.

55. A method for making a food product comprising the steps of:
a. coating a food substrate with said composition of claim 43 to create a coated food substrate;
b. coating said coated food substrate with the edible surface-modifying particle composition of claim 28 to create a edible surface-modifying particle coated food substrate; and
c. optionally cooking said edible surface-modifying particle-coated food substrate.

56. The method of claim 55, wherein said step of cooking is selected from baking, cooking by microwave, cooking by heating on stove-top and freeze-drying.

57. A food product made by the method of claim 56.

58. A starch containing edible surface-modifying particle precursor composition for preparing edible surface-modifying particles, comprising about 75 to about 100% amylopectin by weight of the starch-containing components of the composition.

59. The composition of claim 58, further comprising grain meal.

60. The composition of claim 58, further comprising water.

61. The composition of claim 60, further comprising grain meal in an amount of about 25 to about 75% of the dry weight of the composition.

62. The composition of claim 58, wherein the composition comprises about 0 to about 25% amylase by weight of the starch-containing components of the composition.

63. The composition of claim 58, wherein the composition comprises about 80 to about 100% amylopectin.

64. The composition of claim 63, wherein the composition comprises about 85 to about 100% amylopectin.

65. The composition of claim 64, wherein the composition comprises about 90 to about 100% amylopectin.

66. The composition of claim 58, wherein the composition comprises one or more starches in an amount from about 30 to about 75% of the dry weight of the composition.

67. The composition of claim 66, wherein the composition comprising one or more starches in an amount from about 40 to about 70% of the dry weight of the composition.

68. The composition of claim 67, wherein the composition comprises one or more starches in an amount from about 50 to about 60% of the dry weight of the composition.

69. A method for making a food product comprising the steps of:
a. coating a food substrate with the edible surface-modifying particle composition of claim 28 to create an edible surface-modifying particle coated food substrate; and
b. optionally cooking said edible surface-modifying particle-coated food substrate.

70. The method of claim 69, wherein said step of cooking is selected from baking, cooking by microwave, cooking by heating on stove-top and freeze-drying.

71. The method according to claim 69, wherein said food substrate is raw meat.

72. The method according to claim 69, wherein said food substrate is selected from the group consisting of chicken, beef, lamb, goat, duck, pork, buffalo and venison.

73. The method according to claim 69, wherein said food substrate is fish.

74. The method according to claim 69, wherein said food substrate is selected from the group consisting of salmon, flounder, haddock, tuna, catfish, trout, bass, mahi-mahi, sardines, perch, mackerel, tilapia, sole, pearlspot, butterfish, pomfret, carp, pollack, hake and cod.

75. A food product made by the method of claim 69.

76. An edible adhesive composition comprising:
a. one or more polysaccharides wherein about 80 to about 100% of said polysaccharides have branching, wherein said branched polysaccharides is about 25 to about 75% of the dry weight of the composition; and
b. a grain meal wherein said grain meal is about 25 to about 75% of the dry weight of the composition.

77. An edible adhesive composition of claim 76 comprising:
a. about 30-60% of pregelatinized waxy corn starch;
b. about 20-50% of pregelatinized corn meal;
c. optionally, about 2-10% of pregelatinized rice starch;
d. optionally, about 5-15% of pregelatinized tapioca starch; and
e. optionally, about 0-10% salt;
wherein, all percentages are based on the dry weight of the composition.

78. The edible adhesive composition of claim 77, further comprising water.

79. A composition comprising ingredients of Table I, II or III:
TABLE I

| Ingredient | Dry Weight (%) |
|---|---|
| Pregelatinized Waxy Corn Starch | 30-50% or 35-45% |
| Pregelatinized Rice Starch | 0-10% or 4-8% |
| INSTANT-TEXTRA ® (Modified, | 0-20% or 5-15% |
| Pregelatinized Tapioca Starch) | |
| Pregelatinized Corn Meal | 20-70% or 30-50% |
| Salt | 0-10% or 2-7% |

TABLE II

| Ingredient | Dry Weight (%) |
|---|---|
| Pregelatinized Waxy Corn Starch | 30-50% or 35-45% |
| Pregelatinized Rice Starch | 5-20% or 12-18% |
| Pregelatinized Corn Meal | 20-70% or 30-50% |
| Salt | 0-10% or 2-7% |

TABLE III

| Ingredient | Dry Weight (%) |
|---|---|
| Pregelatinized Waxy Corn Starch | 30-50% or 35-45% |
| Pregelatinized Rice Starch | 3-10% or 4-8% |
| Pregelatinized Waxy Potato Starch | 5-20% or 7-12% |
| Pregelatinized Corn Meal | 20-70% or 30-50% |
| Salt | 0-10% or 2-7%. |
